(19) United States
(12) Patent Application Publication
(10) Pub. No.: US 2008/0000748 A1
(43) Pub. Date: Jan. 3, 2008

(54) Sprocket

(76) Inventor: Chung-Wei Ho, Changhua Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/478,722

(22) Filed: Jul. 3, 2006

(51) Int. Cl. F16D 41/24

(52) U.S. Cl. 192/64

(57) ABSTRACT

A sprocket has an inner collar, an outer collar and a unidirectional device. The outer collar is mounted around the inner collar and has an annular channel and a teeth plate. The annular channel is defined around the outer collar and has a bottom. The teeth plate is formed on and protrudes from the bottom of the annular channel and has twelve teeth evenly formed around the teeth plate. The unidirectional device is mounted between the inner collar and the outer collar to limit the inner collar to unidirectionally rotate with the outer collar. Accordingly, the sprocket with twelve teeth can improve the transmitting efficiency of the sprocket.

### BACKGROUND OF THE INVENTION

1. Field of the Invention

The present invention relates to a sprocket, and more particularly to a sprocket for a bicycle and having twelve teeth.

2. Description of Related Art

A sprocket is mounted on a wheel axle of a bicycle and engages with a chain to transmit the rear wheel of the bicycle when a rider steps the pedal of the bicycle. To engage with a chain, multiple teeth are formed around the sprocket to transmit the rear wheel of the bicycle to rotate. In addition, to secure with a hub on the wheel axle of the bicycle, a central hole is defined through the sprocket and has a diameter corresponding to that of the hub. However, with the diameter of the central hole, the diameter of the whole sprocket cannot be reduced to keep the sprocket have an enough structural strength. Therefore, the amount of teeth on the sprocket cannot be decreased and has at least thirteen teeth on a conventional sprocket. With the number of the teeth increasing, the transmitting efficiency of the sprocket is lowered.

To overcome the shortcomings, the present invention tends to provide a sprocket to mitigate or obviate the aforementioned problems.

### SUMMARY OF THE INVENTION

The main objective of the invention is to provide a sprocket having twelve teeth to improve the transmitting efficiency of the sprocket. The sprocket has an inner collar, an outer collar and a unidirectional device. The outer collar is mounted around the inner collar and has an annular channel and a teeth plate. The annular channel is defined around the outer collar and has a bottom. The teeth plate is formed on and protrudes from the bottom of the annular channel and has twelve teeth evenly formed around the teeth plate. The unidirectional device is mounted between the inner collar and the outer collar to limit the inner collar to unidirectionally rotate with the outer collar.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a sprocket in accordance with the present invention;

FIG. 2 is a perspective view of the sprocket in FIG. 1;

FIG. 3 is a side plane view of the sprocket in FIG. 1; and

FIG. 4 is an operational side plane view of the sprocket in FIG. 3 with a chain.

### DETAILED DESCRIPTION OF PREFERRED EMBODIMENT

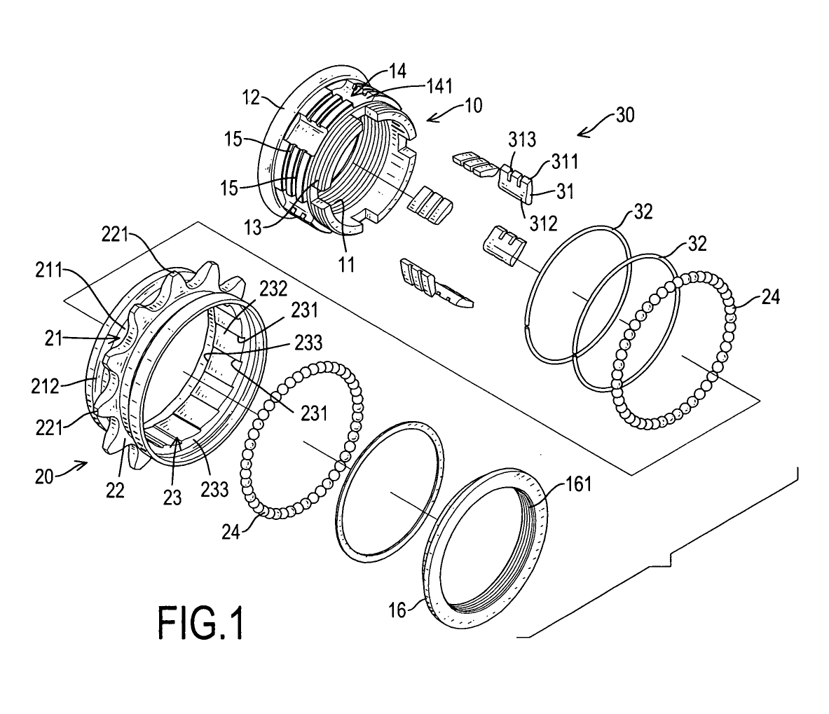

With reference to FIG. 1, a sprocket in accordance with the present invention comprises an inner collar (10), an outer collar (20) and a unidirectional device (30). The inner collar (10) has an inner surface, an outer surface, a first end, a second end, an inner thread (11), a flange (12), an outer thread (13), multiple cavities (14) and two ring grooves (15). The inner thread (11) is defined in the inner surface to screw with a hub on a bicycle to securely connect the inner collar (10) to the hub. The flange (12) is formed around the first end of the inner collar (10). The outer thread (13) is formed on the second end of the inner collar (10). The cavities (14) are defined in the outer surface of the inner collar (10) and each having a recess (141) defined in one end of the cavity (14). In a preferred embodiment, six cavities (14) are defined in the inner collar (10). The ring grooves (15) are defined around the outer surface of the inner collar (10) and communicating with the cavities (14).

The outer collar (20) is mounted around the inner collar (10) and comprises an inner surface, an annular channel (21), a teeth plate (22), multiple ratchet blocks (23) and two shoulders (233). The annular channel (21) is defined around the outer collar (20) and has a bottom (211). The teeth plate (22) is formed on and protrudes from the bottom (211) of the annular channel (21) and has twelve teeth (221) evenly formed around the teeth plate (22). In addition, the annular channel (21) further comprises two inclined side surfaces (212) formed respectively at two sides of the annular channel (21) and respectively at two sides of the teeth plate (22). The ratchet blocks (23) are formed around the inner surface of the outer collar (20), and each ratchet block (23) has a blocking surface (231) and an inclined surface (232). In a preferred embodiment, eighteen ratchet blocks (23) are formed on the outer collar (20). The shoulders (233) are formed on the inner surface of the outer collar (20) respectively at two sides of the ratchet blocks (23).

The unidirectional device (30) is mounted between the inner collar (10) and the outer collar (20) to limit the inner collar (10) to unidirectionally rotate with the outer collar (20). The unidirectional device (30) comprises multiple engaging blocks (31) and two resilient rings (32). The engaging blocks (31) are mounted pivotally around the inner collar (10) and are held respectively inside the cavities (14) in the inner collar (10). Each engaging block (31) has a pivotal end (311), an engaging end (312) and two grooves (313). The pivotal end (311) is pivotally connected to the inner collar (10) and is held in the recess (141) in a corresponding cavity (14). The engaging end (312) selectively abuts against the blocking surface (231) of one of the ratchet blocks (23) on the outer collar (20). The grooves (313) are defined in the engaging block (31) at a face facing to the inner surface the outer collar (20), are parallel with each other and align respectively with the ring grooves (15) in the inner collar (10).

In the preferred embodiment, the unidirectional device (30) has six engaging blocks (31) divided into two groups each having three engaging blocks (31) and held respectively in the six cavities (14) in the inner collar (10). The cavities (14) are also divided into two groups each having three cavities (14). The cavities (14) of each group are evenly arranged around the inner collar (10) to make the engaging blocks (31) of each group being evenly mounted around the inner collar (10), and the cavities (14) of the groups are arranged around the inner collar (10) in an alternative manner. In other words, each cavity (14) of one group is defined between two cavities (14) of the other group. The groups of the cavities (14) have an offset between the groups of the cavities (14), i.e. the distances of each cavity (14) of one group between adjacent cavities (14) of the other group are different. Therefore, the groups of the engaging blocks (31) have an offset between the groups of the engaging blocks (31). Accordingly, the engaging ends (312) of one group of engaging blocks (31) abut against the blocking surfaces (231) of corresponding ratchet blocks (23) when the engaging ends (231) of the other group of engaging blocks (23) abut with the inclined surfaces (232) of corresponding ratchet blocks (23).

The resilient rings (32) are mounted around the engaging blocks (31) and are held respectively in the aligning grooves (313) in the engaging blocks (31) and ring grooves (15) in the inner collar (10).

In addition, a cap (16) is attached to the inner collar (10) to hold the outer collar (20) between the flange (12) on the inner collar (10) and the cap (16) and has an inner thread (161) screwed with the outer thread (13) on the inner collar (10). The cap (16) and the flange (12) on the inner collar (10) correspond respectively to the shoulders (233) on the outer collar (20). Multiple rollers (24) are rotatably mounted between the shoulders (23), the flange (12) on the inner collar (10) and the cap (16) to make the outer collar (20) rotate relative to the inner collar (10) at a lowered friction.

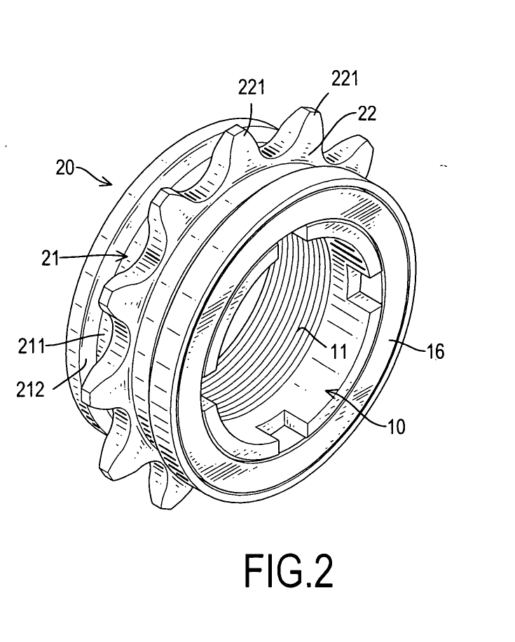

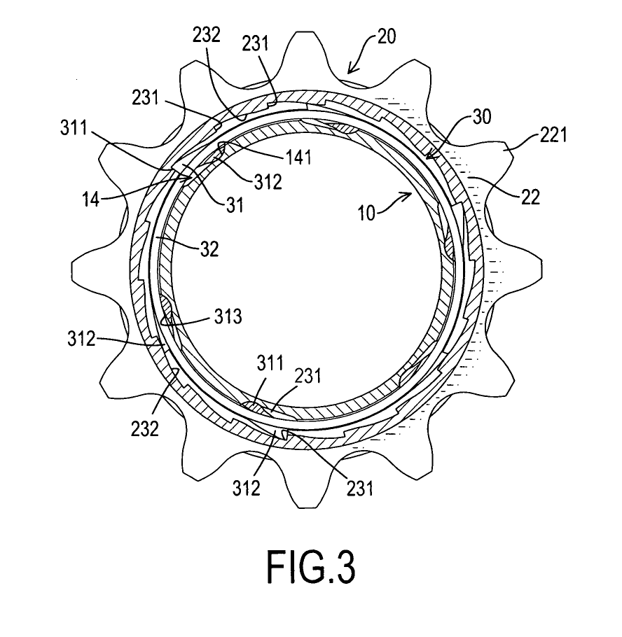

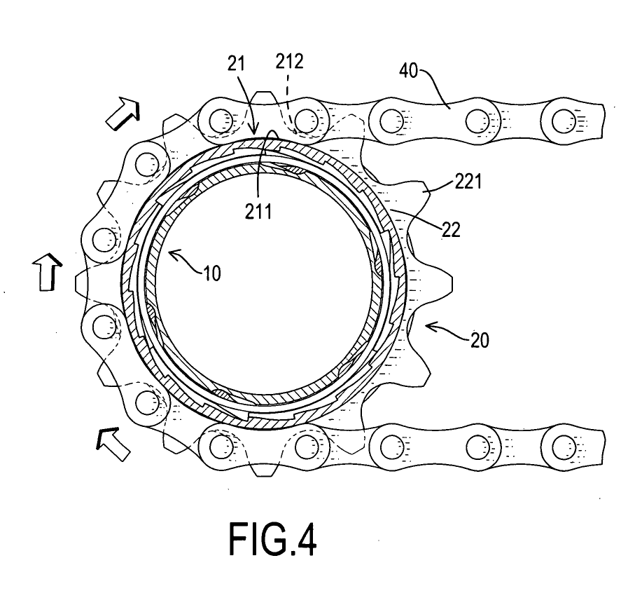

In use, with reference to FIGS. 2 to 4, a chain (40) is mounted around the outer collar (20) and engages with the teeth (221) on the teeth plate (22) of the outer collar (20). When the chain (40) is pulled, the inner collar (10) will be driven to rotate with the outer collar (20) with the engagements between the engaging ends (312) of the engaging blocks (31) and the blocking surfaces (231) of the ratchet blocks (23). With the channel (21) in the outer collar (20), the bottom of the chain (40) can be held inside the channel (21) to make the chain (40) fully engage with the teeth (221) on the teeth plate (22). Therefore, the diameter of the outer collar (20) can be reduced, and the number of the teeth (221) on the teeth plate (22) can be decreased to twelve. Accordingly, the transmitting efficiency of the sprocket with twelve teeth (22) is improved.

In addition, with engaging ends (312) of three engaging blocks (31) engaging with the blocking surfaces (231) of the ratchet blocks (23) and engaging ends (312) of the other three engaging blocks (23) abutting with the inclined surfaces (232) of the ratchet blocks (23), the idle running between the inner collar (10) and the outer collar (20) can be efficiently reduced.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A sprocket comprising:
an inner collar;
an outer collar mounted around the inner collar and comprising
an annular channel defined around the outer collar and having a bottom; and
a teeth plate formed on and protruding from the bottom of the annular channel and having twelve teeth evenly formed around the teeth plate; and
a unidirectional device mounted between the inner collar and the outer collar to limit the inner collar to unidirectionally rotate with the outer collar.

2. The sprocket as claimed in claim 1, wherein the annular channel further comprises two inclined side surfaces formed respectively at two sides of the annular channel and respectively at two sides of the teeth plate.

3. The sprocket as claimed in claim 2, wherein
the outer collar has multiple ratchet blocks formed around an inner surface of the outer collar and each ratchet block has a blocking surface and an inclined surface;
the unidirectional device comprises
multiple engaging blocks mounted pivotally around the inner collar and each having
a pivotal end pivotally connected to the inner collar;
an engaging end selectively abutting against the blocking surface of one of the ratchet blocks on the outer collar; and
two grooves defined in the engaging block at a face facing to the inner surface the outer collar and parallel with each other; and
two resilient rings mounted around the engaging blocks and held respectively in the grooves in the engaging blocks.

4. The sprocket as claimed in claim 3, wherein the unidirectional device has six engaging blocks divided into two groups each having three engaging blocks;
the engaging blocks of each group are evenly mounted around the inner collar; and
the groups of the engaging blocks have an offset between the groups of the engaging blocks to make the engaging ends of one group of engaging blocks abut against the blocking surfaces of corresponding ratchet blocks when the engaging ends of the other group of engaging blocks abut with the inclined surfaces of corresponding ratchet blocks.

5. The sprocket as claimed in claim 4, wherein
the inner collar has
an outer surface;
a first end;
a second end;
a flange formed around the first end of the inner collar; and
an outer thread formed on the second end of the inner collar;
six cavities defined in the outer surface of the inner collar and holding respectively the ratchet blocks inside, and each having a recess defined in one end of the cavity to hold the pivotal end of a corresponding ratchet block inside; and
two ring grooves defined around the outer surface of the inner collar and communicating with the cavities to respectively hold the resilient rings inside; and
a cap is attached to the inner collar to hold the outer collar between the flange on the inner collar and the cap and has an inner thread screwed with the outer thread on the inner collar.

6. The sprocket as claimed in claim 5, wherein
the outer collar has two shoulders formed on the inner surface of the outer collar respectively at two sides of the ratchet blocks and corresponding respectively to the flange on the inner collar and the cap; and
multiple rollers rotatably mounted between the shoulders, the flange on the inner collar and the cap.

7. The sprocket as claimed in claim 1, wherein
the outer collar has multiple ratchet blocks formed around an inner surface of the outer collar and each ratchet block has a blocking surface and an inclined surface;
the unidirectional device comprises
multiple engaging blocks mounted pivotally around the inner collar and each having
a pivotal end pivotally connected to the inner collar;
an engaging end selectively abutting against the blocking surface of one of the ratchet blocks on the outer collar; and
two grooves defined in the engaging block at a face facing to the inner surface the outer collar and parallel with each other; and
two resilient rings mounted around the engaging blocks and held respectively in the grooves in the engaging blocks.

8. The sprocket as claimed in claim 7, wherein the unidirectional device has six engaging blocks divided into two groups each having three engaging blocks;
the engaging blocks of each group are evenly mounted around the inner collar; and
the groups of the engaging blocks have an offset between the groups of the engaging blocks to make the engaging ends of one group of engaging blocks abut against the blocking surfaces of corresponding ratchet blocks when the engaging ends of the other group of engaging blocks abut with the inclined surfaces of corresponding ratchet blocks.

9. The sprocket as claimed in claim 8, wherein
the inner collar has
an outer surface;
a first end;
a second end;
a flange formed around the first end of the inner collar; and
an outer thread formed on the second end of the inner collar;
six cavities defined in the outer surface of the inner collar and holding respectively the ratchet blocks inside, and each having a recess defined in one end of the cavity to hold the pivotal end of a corresponding ratchet block inside; and
two ring grooves defined around the outer surface of the inner collar and communicating with the cavities to respectively hold the resilient rings inside; and
a cap is attached to the inner collar to hold the outer collar between the flange on the inner collar and the cap and has an inner thread screwed with the outer thread on the inner collar.

10. The sprocket as claimed in claim 9, wherein
the outer collar has two shoulders formed on the inner surface of the outer collar respectively at two sides of the ratchet blocks and corresponding respectively to the flange on the inner collar and the cap; and
multiple rollers rotatably mounted between the shoulders, the flange on the inner collar and the cap.
